(19) United States
(12) Patent Application Publication
(10) Pub. No.: US 2012/0207430 A1
(43) Pub. Date: Aug. 16, 2012

(54) ACTIVE OFF-AXIS FIBER OPTIC SLIP RING

(76) Inventors: Hong ZHANG, Pennington, NJ (US); Boying B. ZHANG, Pennington, NJ (US); Louis D. VIOLANTE, Pennington, NJ (US)

(21) Appl. No.: 13/028,464

(22) Filed: Feb. 16, 2011

(51) Int. Cl. G02B 6/42

(52) U.S. Cl. 385/26

(57) ABSTRACT

An active off-axis optic slip ring system is disclosed. The invention eliminates the huge number of fiber bundles and photodiodes in most published patents. A couple of conventional optical components such as mirrors and prisms are used to transmit optical signals with high, quality and low optic losses. The optical signal pick-up is realized through a pair of prisms mounted on the rotor of motors. It is an active, hi-directional rotational optical transmission device which could be used for multi-mode, or single mode fibers without the limitation to the through bore diameters.

### BACKGROUND OF THE INVENTION

1. Field of the Invention

The invention is related to off-axis multi-channel fiber optic slip ring to provide transmission of data in optic form between a mechanically rotational interface with a through bore.

2. Description of Related Art

It is well known that the devices to transmit optical data between two independently rotational members are called fiber optical rotary joints, or optical slip ring. There are single channel, two channel and multi-channel fiber optical rotary joints. However, most of them are categorized as on-axis fiber optical rotary joint because the optical paths are located along the axis of rotation, or occupy the central space along the axis of rotation. If the central space along the rotational axis is not accessible, the optical light paths would not be allowed to path through the central area along the rotational axis. Such devices are usually called off-axis optical slip ring.

The simplest, off-axis slip ring has been described in U.S. Pat. No. 4,492,427, which comprises two opposed annular fiber bundles and increasing the number of such concentric annular bundles radially would make the device multi-channeled. The concentric, annular fiber bundle fiber optic slip rings are bi-directional but do have a modulated light loss dependent on the rotational angle. For minimizing the importance of the modulation, a digitized signal rather than an analog signal has to be used. This off-axis slip ring only could be used for multi-mode fibers, not single mode fibers.

U.S. Pat. No. 4,460,242 discloses an optical slip ring employing optical fibers to allow light signals applied to any one or all of a number of inputs to be reproduced at a corresponding number of outputs of the slip ring in a continuous manner. It includes a rotatable output member, a stationary input member and a second rotatable member which is rotated at half the speed of the output member like a de-rotator. The input member having a plurality of equispaced light inputs and the output member having a corresponding number of light outputs and the second rotatable member having a coherent strip formed of a plurality of bundles of optical fibers for transmitting light from the light inputs on the input member to the light outputs.

Another U.S. Pat. No. 4,943,137 assume the similar idea, where, a de-rotating, transmissive intermediate optical component with an array of lensed optical transmitters and receivers respectively mounted on the rotor and stator. The derotating, intermediate optical component comprises an image conduit, image transporter, or coherent optical fiber bundle of close-packed monotibers or multifibers.

But actually, it is almost no way to handle and arrange so many fibers on said rotatable members, especially for large diameter slip ring. The optical loss is very obvious for multi-mode fibers. It is almost impossible to use single mode fibers. The effect of damaged fibers, the presence of debris, separation distances, component tolerances, or backlash in the gearing also cause problems.

A more sophisticated approach can be found in U.S. Pat. No. 6,907,161. The patent uses multiple inputs and pick-ups to send and receive data across members that have large diameters. The use of multiple inputs and pick-ups is required to keep the optical signals at a level that is sufficiently high to permit the photodiode receivers to operate. Wave guides are employed. The multiple inputs and pick-ups also cause a rapid rise and fall of the signal because the signal reflects from one area of the waveguide to another. The drawback is to use photodiode receivers which is an electro-optical device, so that the output signal is electrical and the power must be high. Besides, there is a time jitter thus limiting the data rate.

### SUMMARY OF THE INVENTION

The prior patent, U.S. Pat. No. 7,792,400, by the same incentors, disclosed an invention for both single channel and multi-channel off-axis fiber optic slip ring, which is a passive fiber optic off-axis slip ring, including mirror, or mirror array, prisms, optic coupler and gears. The object of the present invention is to replace the gears by motors to provide an active, bidirectional, no time jitter, low-loss off-axis optic slip ring which could be used for multi-mode, or single mode fibers.

### BRIEF DESCRIPTION OF THE DRAWINGS

FIGS. 1a & 1b are the first embodiment of the invention.

FIGS. 2a & 2b illustrate the right hand rule for rotation vectors.

FIG. 3 is an outline diagram of the off-axis slip ring in FIGS. 1a & 1b.

FIGS. 4a & 4b demonstrate the second embodiment of current invention.

FIG. 5 is the enlarged view for an on-axis multi-channel optic rotary joint used in FIGS. 4a & 4b.

### DETAILED DESCRIPTION OF THE INVENTION

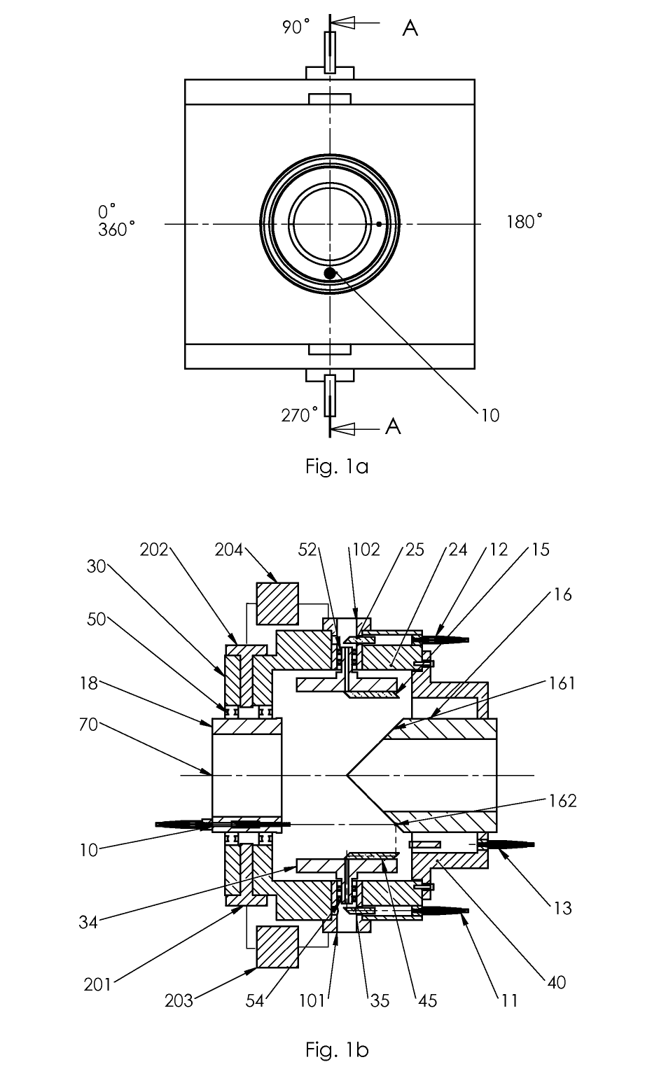

As shown in FIGS. 1a and 1b, a typical embodiment of a single channel off-axis optic slip ring in the present invention comprises rotor 18, stator 30, mirror array 161 and 162, rhomboid prisms 15 and 45, right angle prisms 25 and 35, motor 101 and 102, collimators 10,11,12, and coupler 13. A pair of bearings 50 are mounted between rotor 18 and stator 30 to provide the main rotational interface. Motor bearings 52, and 54 are used to rotationally support the motor shaft 24 and 34 in the stator 30. Collimators 10 and more (depends on how many channel would be built), are mounted on rotor 18 in circumferential direction at a different distances to the common rotational axis 70. The axis of the collimator 10, are parallel to the main rotational axis 70. The rotor 18 and the mirror frame 16 are hollow along said common rotational axis so that a through bore is provided, leaving the central part of the interface totally free. That means all the optical signals would not be allowed to pass through the through bore.

A rhomboid prism 45 is attached on the motor rotor 34. Said mirror frame 16 is co-axial with the common rotational axis 70 with two flat mirror surfaces 161 and 162, which are perpendicular each other and symmetrical to the common rotational axis. The mirror frame 16 is stationary by fixed to stator 30 through holder 40.

Encoders 201 and 202 are used to detect the rotation speed and direction of rotor 18. The signals from encoder 201 and 202 are transmitted to motor controllers 203 and 204 respectively to control the motion of motors 101 and 102.

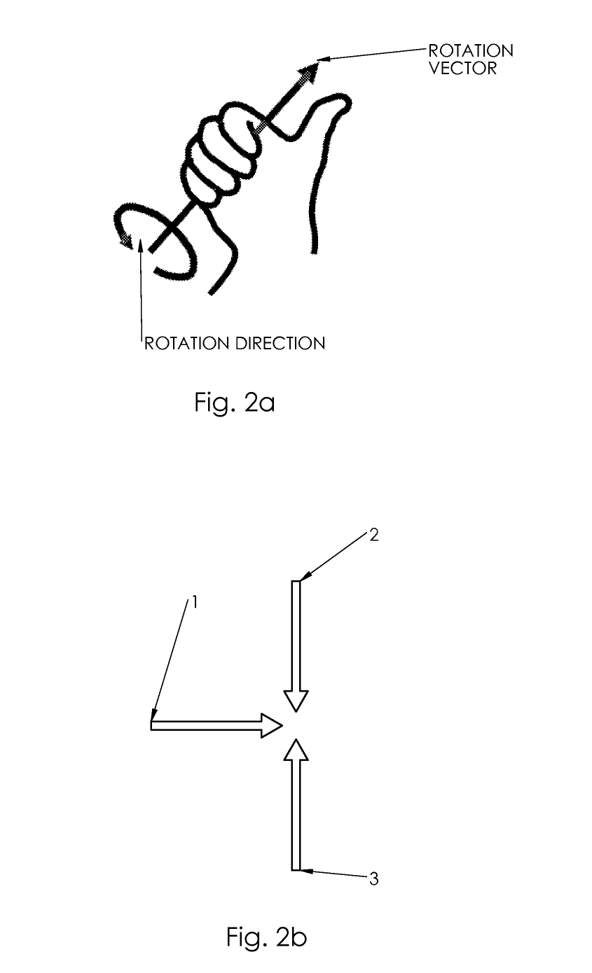

The speed ratio between rotor 18 and motor shaft 24 and 34 is designed to 1:1. The rotation directions of motors are shown in FIGS. 2a & 2b, where a right hand rule is applied on the rotation directions between rotor 18 and motor shaft 24 and 34. Refers to FIG. 2a, if fingers of right hand point in the direction of rotation, the thumb points in the direction of rotation vector. Thus the direction of rotation vectors for rotor 18 and motor shaft 24 and 34 are represented by vector 1, 2, and 3 respectively, as shown in FIG. 2b: all the rotation vectors either point inward, or point outward.

When the collimator 10 rotates within 180° and 360°, the light beam emitted from collimator 10 will be reflected by the mirror surface 162 to rhomboid prism 45 and reflected two times by the paralleled surfaces of rhomboid prism 45 to the central hole of motor shaft 34. Another similar right angle prism 35 fixed in the stator 30 would pickup the light beam to the collimator 11, which is also fixed on stator 30. Because the counterpart of the above described motor, rhomboid prisms, right angle prisms, and collimators are also symmetrically arranged to the common axis 70, when the collimator 10 rotates between 0° and 180°, the light beam emitted from collimator 10 will be reflected by mirror surface 161, prism 15 and 25, then coupled to collimator 12.

As shown in s. 3, the collimator 11 and 12 are connected to an optical coupler 13, which is also fixed to stator 30 through cap 40.

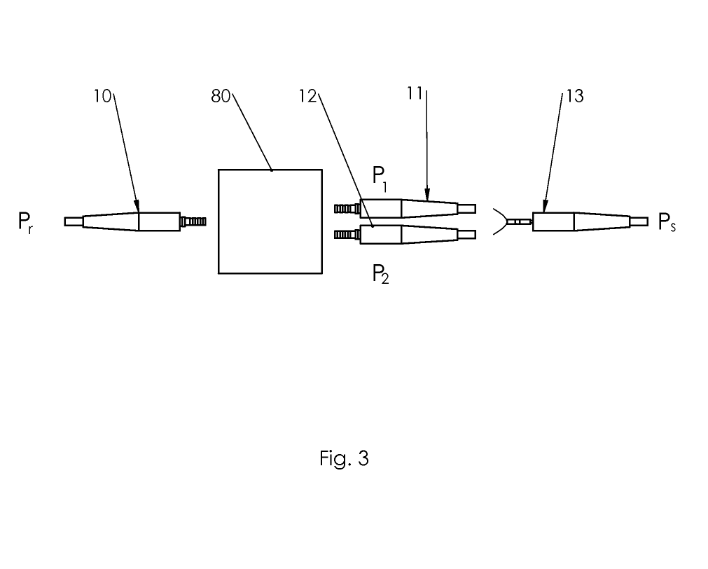

FIG. 3 is an outline diagram of the off-axis slip ring in FIGS. 1a & 1b, where, member 80 represents the opto-mechanical transformer, including all the motors, rhomboid prisms, right angle prisms, mirrors and bearings. Light beam would be transmitted from collimator 10 to coupler 13, vise versa. If the power of optical signal from collimator 10 is Pᵣ, and the power of optical signal through collimator 11 and 12 are P₁ and P₂ respectively, then the power of optical signal to coupler 13, Pₛ, can be expressed as follows:

$${P}_{s} = \begin{matrix}{P}_{2} , -- -- - ( 0 \sim 180 ° ) \\ {P}_{1} , -- -- - ( 180 ° \sim 360 ° ) ,\end{matrix}$$

where, P₂≈Pᵣ, - - - (0˜180°), P₁≈Pᵣ, - - - (180°˜360°),

(Note: the angle refers to the rotation position of rotor 18 in FIG. 1b)

Due to the opto-mechanical transmission error, usually, P₁≠P₂, and P₁−P₂≦1 dB.

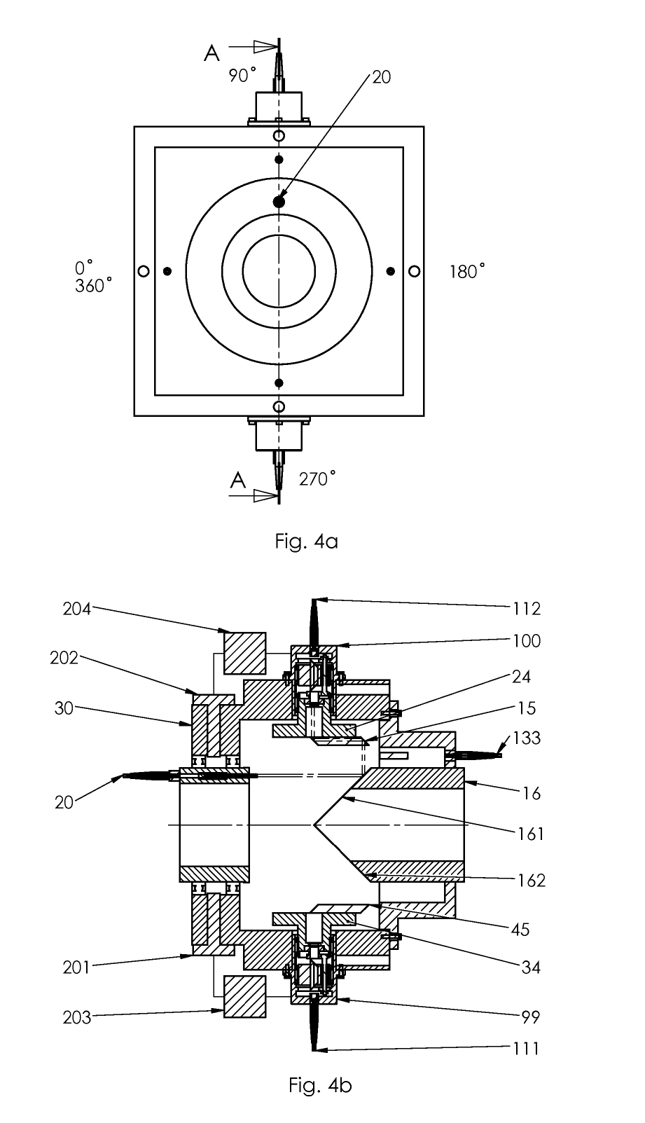

In FIGS. 4a and 4b, a preferred embodiment of the current invention for multi-channel off-axis fiber optic slip ring is illustrated, where, two on-axis multi-channel fiber optic rotary joints are integrated in motor 99 and 100. They are co-axially arranged with motor shaft 34 and 24 respectively. To compare with FIG. 1a and FIG. 1b, almost all the opto-mechanical members are the same in FIG. 4a and FIG. 4b as in FIG. 1a and FIG. 1b. The collimator 10 in FIG. 1a and FIG. 1b is replaced by a collimator bundle 20 in FIG. 4a and FIG. 4b in the same position on rotor 18. The collimator 11, or 12 in FIG. 1b becomes a multi-collimator bundle 111, or 112 in FIG. 4b in the similar position on stator 30. The collimator bundle 20 could transmit multi-channel optical signals. The light beams emitted from collimator bundle 20 should be parallel one another. For example, the paralleled light beams from the collimator bundle 20 would be reflected by the flat mirror surface 162, or 161, and then reflected two times by the rhomboid prism 15, or 45, to get into the central bore of the motor shaft 24, or 34 along the rotational axis of gear 34, or gear 24. When the collimator bundle 20 rotates with the rotor 18 around the common rotational axis 70, the paralleled light beams from the collimator bundle 20 will rotate around the axis of motor shaft 24, or 34, in a stable pattern after transmitted by the mirror 16 and rhomboid prism 15, or 45. The on-axis fiber optic rotary joint integrated in motor 99, or 100, will allow the rotating paralleled light beams from the collimator bundle 20 to be coupled with the multi-collimator bundle 111, 112, which is fixed to the stator 30. Like in FIG. 1b, a coupler bundle 133 will couple the corresponding fibers from collimator bundle 111 and 112.

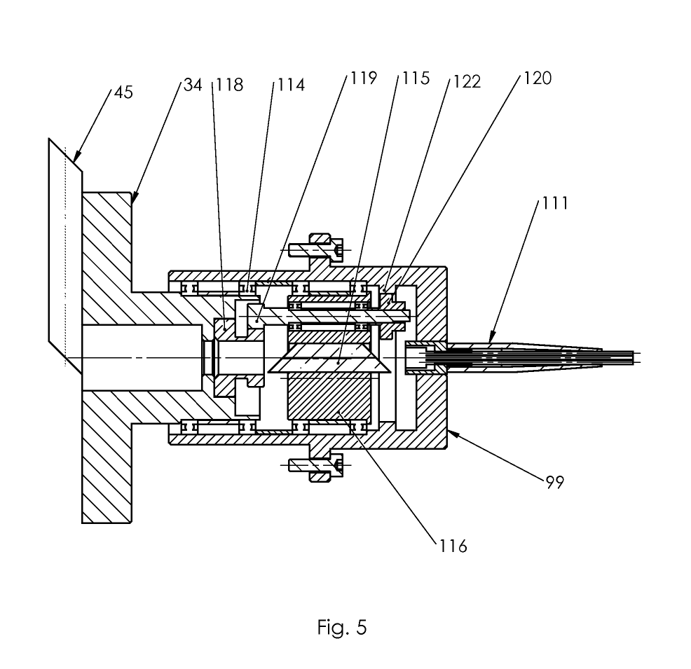

To explain how the on-axis fiber optic rotary joint (FORJ) integrated in motor 99, or 100 works, the cross section view of a preferred on-axis fiber optic rotary joint is enlarged in FIG. 5. The motor shaft 34, or 24, is also the rotor of FORJ. A sun gear 118 is fixed with rotor 34, which is engaged with planet gear 119, while another planet gear 120 is engaged with an internal gear 122, which is fixed with motor housing 99. A Dove prism 115 is co-axially fixed inside the through bore of carrier 116. The planet gear system is such designed so that the carrier 116 will rotate at the half speed as that of the rotor 34 and in the same rotational direction. In this way, the rotating paralleled light beams on the rotor 34 will be coupled into corresponding collimators in the collimator bundle 111, or 112 after pass through the Dove prism 115.

The on-axis fiber optic rotary joint in FIG. 5 is only one typical on-axis fiber optic rotary join. Any other types of on-axis fiber optic rotary joint could be used in present invention in the same manner as the on-axis fiber optic rotary joints in FIG. 4a and FIG. 4b.

I claim:

1. An active off-axis fiber optic slip ring assembly for use with single mode, or multi-mode optic fibers comprising:
a stator with a central through bore and a rotor with a central through bore, able to rotate independently of each other on a common axis through a pair of bearings;
a first fiber optical collimator mounted on said rotor and able to rotate with said rotor around said common axis;
a hollow mirror array with central through bore, fixed in said stator, coaxially orientated with said rotor at a specific distance from the inner portion of the rotor;
a first motor having a first motor shaft with a through bore, mounted in a bore of said stator;
a first rhomboid prism attached on the inward end portion of said first motor shaft radially, with one end portion of the rhomboid prism covering said through bore of said motor shaft on the inward side of said motor shaft;
a first right angle prism attached on said stator, parallel located with said first rhomboid prism with one end portion of the rhomboid prism covering said through bore of said first motor shaft on the outward side;
a second fiber optical collimator fixed in a bore of said stator, coaxially aligned with the said first right angle prism with a specific axial distance;
a second motor having a second motor shaft with a through bore, mounted in another bore of said stator;
a second rhomboid prism attached on the inward end portion of said second motor shaft radially, with one end portion of the rhomboid prism covering said through bore of said second motor shaft on the inward side of said second motor shaft;
a second right angle prism attached on said stator, parallel located with said second rhomboid prism with one end portion of said second rhomboid prism covering said through bore of said second motor shaft on the outward side;
a third fiber optical collimator fixed in a bore of said stator, coaxially aligned with the said second right angle prism with a specific axial distance; and
an optical coupler, fixed on said stator, connected with said second and said third fiber optical collimator on one side.

2. An off-axis fiber optic slip ring assembly according to claim 1, wherein said both first motor and second motor having an encoder and controller to detect the motion of said rotor and to control the motion of said motors; both said first motor and second motor can be any kind of motors, or rotation actuators, e.g., DC motor, AC motor, stepper motor, hydraulic actuator, or pneumatic actuator, etc.

3. An off-axis fiber optic slip ring assembly according to claim 1, wherein the rotation/axis of said first motor shaft, and said second motor shaft being concentric and being perpendicular to said common axis.

4. An off-axis fiber optic slip ring assembly according to claim 1, wherein said hollow mirror array at least having a first optical mirror surface and second optical mirror surface, being perpendicular each other, and symmetrical on said common axis.

5. An off-axis fiber optic slip ring assembly according to claim 1, wherein the optical signal could be emitted from said first collimator, when said rotor rotates between 0° to 180°, reflected by one of said optical mirror surfaces of said hollow mirror array, then reflected by said first rhomboid prism, after passing through the through bore of one of said motor shafts, reflected by one of said right angle prisms and get into said second collimator; and when said rotor rotates between 180° to 360°, the optical signal from said first collimator, reflected by said another optical mirror surface, then reflected by said another rhomboid prism, after passing through the through bore of said another motor shaft, reflected by said another right angle prism and getting into said third collimator; each of said second collimator and third collimator optically connected to one port of said optical coupler; and said optical signal also could be emitted from said optical coupler, in an inverse way, getting into said first collimator.

6. An off-axis fiber optic slip ring assembly for use with single mode, or multi-mode optical fibers comprising:
a stator with a central through bore and a rotor with a central through bore, able to rotate independently of each other on a common axis through a pair of bearings;
a first fiber optical collimator array, including multi-channel fiber optic collimators, mounted on said rotor and able to rotate with said rotor around said common axis;
a hollow mirror array with central through bore, fixed in said stator, coaxially orientated with said rotor at a specific distance from the inner portion of the rotor;
a first motor having a first motor shaft with a central hole, mounted in a bore of said stator, and integrated with a first on-axis multi-channel fiber optic rotary joints;
a first rhomboid prism attached on the inward end portion of said first motor shaft radially, with one end portion of the rhomboid prism covering said central hole of said motor shaft on the inward side of said first motor shall;
a second fiber optical collimator array, including multi-channel fiber optic collimators, coaxially fixed on the stator side of said first on-axis multi-channel fiber optical rotary joint;
a second motor having a second motor shaft with a central hole, mounted in a bore of said stator, and integrated with a second on-axis multi-channel fiber optic rotary joints;
a second rhomboid prism attached on the inward end portion of said second motor shaft radially, with one end portion of the rhomboid prism covering said central hole of said second motor shaft on the inward side of said second motor shaft;
a third fiber optical collimator array, including multi-channel fiber optic collimators, coaxially fixed on the stator side of said second on-axis multi-channel fiber optical rotary joint; and
an optical coupler array, including multi-channel optical couplers, fixed on said stator, connected with said second and said third fiber optical collimator on one side.

7. An off-axis fiber optic slip ring assembly according to claim 6, wherein said both first motor and second motor having an encoder and controller to detect the motion of said rotor and to control the motion of said motors; both said first motor and second motor can be any kind of motors, or rotation actuators. e.g., DC motor, AC motor, stepper motor, hydraulic actuator, or pneumatic actuator, etc.

8. An off-axis fiber optic slip ring assembly according to claim 6, wherein the rotation axis of said first motor shaft, and said second motor shaft being concentric and being perpendicular to said common axis.

9. An off-axis fiber optic slip ring assembly according to claim 6, wherein said hollow mirror array at least having a first optical mirror surface and second optical mirror surface, being perpendicular each other, and symmetrical on said common axis.

10. An off-axis fiber optic slip ring assembly according to claim 6, wherein the optical signal could be emitted from said first collimator array, when said rotor rotates between 0° to 180°, reflected by one of said optical mirror surfaces of said hollow mirror array, then reflected by said first rhomboid prism, after passing through said central hole of one of said motor shafts, and get into one of said on-axis multi-channel fiber optic rotary joints, and exit to said second collimator array; and when said rotor rotates between 180° to 360°, the optical signal from said first collimator array, reflected by said another optical mirror surface, then reflected by said another rhomboid prism, after passing through the central hole of said another motor shaft, and get into another said on-axis multi-channel fiber optic rotary joints, and exit to said third collimator array; each of said second collimator array and third collimator array optically connected to one port of said optical coupler array respectively; and
said optical signal also could be emitted from said optical coupler array, in an inverse way, getting into said first collimator array.
